(19) United States
(12) Patent Application Publication
(10) Pub. No.: US 2009/0220926 A1
(43) Pub. Date: Sep. 3, 2009

(54) System and Method for Correcting Speech

(76) Inventor: Gadi Rechlis, Tel-Aviv (IL)

Correspondence Address: NIXON & VANDERHYE, PC, 901 NORTH GLEBE ROAD, 11TH FLOOR, ARLINGTON, VA, 22203, US

(21) Appl. No.: 11/992,251

(22) PCT Filed: Sep. 19, 2006
(86) PCT No.: PCT/IL2006/001096

§ 371 Date: Feb. 20, 2009

(30) Foreign Application Priority Data
Sep. 20, 2005 (IL) 170981

(51) Int. Cl. G09B 19/04; G09B 5/00

(52) U.S. Cl. 434/185; 434/308; 434/167

(57) ABSTRACT

A method and device for correcting mispronunciations of a user, the method comprising the following steps: providing a database comprising a plurality of records each of which comprising at least a textual and a vocal representation of a specific word; training a speech recognition module to recognize spoken utterances of said user comprising the words represented by said records; generating word models for each recognized spoken word; associating each word model with a respective database record; after training said speech recognition module with sufficient words receiving spoken utterance from said user; extracting a sequence of words from said spoken utterance and generating a word model for each extracted word; comparing said word models to the word models associated with said database records; constructing an audible output comprising vocal representations obtained from records which their word models matched word models generated for said extracted word, wherein said word models comprises features extracted from data of the words spoken by said user.

### FIELD OF THE INVENTION

The present invention relates to a method and device for correcting speech. More particularly, the invention relates to a method and device for aiding individuals suffering from speech disabilities by correcting the user's mispronunciations.

### BACKGROUND OF THE INVENTION

There were various attempts to aid those who suffer from mispronunciation disabilities, most of which utilizes computerized systems for identifying users' mispronounced utterance by digitizing users' spoken utterance and comparing the digital representation to a database of properly pronounced utterances. In some of these attempts methods for teaching the users to correctly pronounce such mispronunciations are proposed.

WO 01/82291 describes a speech recognition and training method wherein a pre-selected text is read by a user and the audible sounds received via a microphone are processed by a computer comprising a database of digital representations of proper pronunciation of the read audible sounds. An interactive training program is used to enable the user to correct mispronunciation utilizing a playback of the properly pronounced sound from the database.

U.S. Pat. No. 6,413,098 describes a method and system for improving temporal processing abilities and communication abilities of individuals with speech, language and reading based communication disabilities wherein a computer software is used to modify and improve fluent speech of the user.

WO 2004/049283 describes a method for teaching pronunciation which may provide feedback to a user on how to correct pronunciation. The feedback may be provided for individual phonemes on correct tongue position, correct lip rounding, or correct vowel length.

EP 1,083,769 describes a hearing aid capable of detecting speech signals, recognizing the speech signals, and generating a control signal for outputting—the result of recognition for presentation to the user via a display. The speech uttered by a hearing-impaired person or by others, is worked on or transformed for presentation to the user.

WO 99/13446 describes a system for teaching speech pronunciation, wherein a plurality of speech portions stored in a memory for playback for indicating a student a speech portion to be practiced. The user's utterance is compared with the speech portion to be practiced and the accuracy of the utterance is evaluated and provided to the user.

The pronunciation evaluation system described in EP 1,139,318 utilizes stored reference voice data of text of foreign language textbooks for various levels of users. When a text is selected, the corresponding reference voice data is output from a voice synthesis unit. The user imitates the pronunciation and the voice data of the user is analyzed utilizing spectrum analysis by a voice recognition unit to determine user's pronunciation level by comparing it with the stored reference. If the user pronunciation is bad, the practice is repeated for the same text many times.

A computerized learning system is described in US 2002/086269 wherein the user says a sentence that is received and analyzed relative to a reference. User's mistakes are reported to the user and the reference sound is played to the user. User response is then received and analyzed to determine its correctness. A corrective feedback may be provided by modifying the user's response by correcting the identified mistake in the user's recorded response to reflect the correct way of producing the sound.

The methods described above have not yet provided satisfactory solutions for aiding those suffering from speech disabilities to vocally communicate and correct their mispronunciations. Therefore there is a need for solutions allowing to instantly correct speaker's mispronunciations.

It is therefore an object of the present invention to provide a method and device for recognizing individual's mispronunciations and for correcting said mispronunciations instantly after they are spoken.

It is another object of the present invention to provide a method and device for aiding speakers to vocally communicate using an unfamiliar language.

Other objects and advantages of the invention will become apparent as the description proceeds.

### SUMMARY OF THE INVENTION

The present invention is generally directed to speech-aiding, and more particularly, to a method and device for aiding those who suffer from speech disabilities. In general the invention utilizes speech recognition techniques for recognizing the words in utterances spoken by a user and generating a corresponding audible output in which the words are correctly pronounced.

The term Word Model (WM) is used herein to refer to a vocal signature representing the word as pronounced by the user. WMs typically comprise statistical and/or probability features obtained utilizing spectral or cepstral analysis features extracted from a digitized word spoken by the user.

The invention preferably comprise a training stage in which a speech-aid device is trained to recognize the words comprised in spoken utterances of a user, word models (WM) are generated for each spoken words, and each WM is associated with, and stored in, a database record comprising Vocal Representation (VR) of the word, wherein the VRs constitute correct pronunciation of the words that may be outputted (playback) by the speech-aid device. During operation, a sequence of words in the user's spoken utterance is processed and respective WMs are generated for each spoken word. The WMs are compared and matched to the WMs stored in the database and the corresponding VRs of the words are played in sequence via an audible output device, thus providing correct pronunciation of the user's spoken utterance.

According to one aspect the present invention is directed to a speech aiding device comprising DSP means for digitizing audio signals received via an audio input device and for converting digital data into an audible output via an audio output device, a processing unit adapted to receive and transfer data from/to said DSP means and execute programs comprising speech recognition module(s), memory(s) adapted to transfer/receive data to/from said processing unit, and a database stored in the memory(s), wherein said database comprises a plurality of records each of which comprising at least a WM and a textual and a VR of a specific word, and wherein said WM comprises features extracted from a digitized word spoken by said user.

The device may further comprise a text input device attached to the processing unit for inputting text, additional processing means embedded in the DSP means, and/or a display device attached to the processing unit.

Preferably, the processing unit is a personal computer, a pocket PC, or a PDA device. The memory(s) may comprise one or more of the following memory device(s): NVRAM, FLASH memory, magnetic disk, R/W optic disk.

According to another aspect the invention is directed to a method for correcting mispronunciations of a user, comprising providing a database comprising a plurality of records each of which comprising at least a textual and a VR of a specific word, training a speech recognition module to recognize spoken. utterances of said user comprising the words represented by said records, generating WMs for each recognized spoken word, associating each WM with a respective database record,
after training the speech recognition module with sufficient words receiving spoken utterance from the user, extracting a sequence of words from the spoken utterance and generating a WM for each extracted word, comparing the WMs to the WMs associated with the database records, constructing an audible output comprising VRs obtained from records which their WMs matched WMs generated for the extracted words,
wherein the WMs comprises features extracted from data of the words spoken by the user.

The method may further comprise utilizing a language model (e.g., trigram) and/or carrying out ontology-based contextual tests to eliminate the matching of wrong words from the database.

Preferably, the VRs of each database record constitute correct pronunciation of the word associated with said record.

Optionally, the database records comprise VRs of the words in one or more languages, and the language of VRs to be used is selected by the user.

### BRIEF DESCRIPTION OF THE DRAWINGS

In the drawings:

FIG. 1 is a block diagram generally illustrating a speech-aid device according to a preferred embodiment of the invention;

FIG. 2 schematically illustrates a possible database records structure according to the invention;

FIG. 3 is a flowchart exemplifying the training and operation stages of the speech-aid device of the invention; and

FIG. 4 is a flowchart exemplifying a possible recognition procedure.

### DETAILED DESCRIPTION OF PREFERRED EMBODIMENTS

The present invention is directed to a method and device for aiding those who suffer from speech disabilities. In general the invention utilizes speech recognition techniques for recognizing the words in utterances spoken by a user and generating a corresponding audible output in which the words are correctly pronounced.

Initially, a training stage is carried out in which a speech-aid device is trained to recognize the words comprised in spoken utterances of a user, WMs are generated for each recognized spoken word, and each WM is associated with, and stored in, a database record comprising VR of the word, wherein the VR constitute correct pronunciation thereof. During operation, a sequence of words in the user's spoken utterance is recognized and a corresponding WM is generated to each spoken word. The WMs are compared and matched to the WMs stored in the database and the corresponding VRs of the words are played in sequence via an audible output device, thus providing correct pronunciation of the user's spoken utterance.

FIG. 1 schematically illustrates a speech-aid device 6 according to a preferred embodiment of the invention wherein the invention is implemented utilizing a Processing Unit (PU) 12 linked to database (DB) 13, Digital Signal Processing (DSP) unit 11, text input device (KBD) 10, and Display 14. The DSP unit 11 is linked to audio input device 15, audio output device 16, and (optionally) to DB 13. The data link connecting PU 12 to DSP 11 may be implemented by an external data bus (e.g., 32 bit), capable of providing relatively high data transfer rates (e.g., 400-800 MB/sec).

DB 13 may be implemented using a fast access memory device such as NV-RAM, FLASH, or fast magnetic or R/W optic disk. The (optional) data links connecting DB 13 to DSP 11 and to PU 12 may be also implemented by an external data bus, or by utilizing conventional data cable connectivity, such as SCSI or IDE/ATA.

PU 12 preferably comprises memory device(s) (not shown) required for storing data and program code needed for its operation. Of course, additionally or alternatively, external memory device(s) (not shown) linked to PU 12 may be used. DSP 11 comprises Analog-to-digital (A/D) and digital-to-Analog (D/A) converter(s) (not shown) for digitizing audible signals 18 received via audio input device 15, and for converting digital data into analog equivalents suitable for generating audible signals 17 via audio output device 16.

DSP 11 may include filtration means for filtering noise, such as background noise, that may accompany the user's utterance. Alternatively or additionally, filtration may be performed by PU 12 by utilizing digital filtration methods. DSP 11 may also comprise memory device(s) (not shown) for storing digitized audible signals data, as well as other data that may be needed for its operation. Obviously, DSP 11 may be integrated into PU 12, but it may be advantageous to use an independent DSP unit comprising independent processing means and memory(s) that may be directly linked to DB 13 (indicated by dotted arrow line in FIG. 1), for carrying out speech processing tasks, which will be discussed hereinafter.

Speech recognition typically comprise extracting the individual words comprised in the digital representation of the user's spoken utterance, and for each extracted word generating a corresponding WM according to statistical and probability features obtained utilizing spectral or cepstral analysis. These tasks may be performed by PU 12 utilizing suitable speech recognition software tools. While discrete speech recognition may be employed, the system of the invention preferably utilizes continuous speech recognition tools. For example, state of the art continuous speech recognition programs may be used, or modifications thereof, such as NaturallySpeaking or ViaVoice by ScanSoft Ltd. For example, Dynamic Time Warping (DTW) algorithms (alone and/or in combination with HMMs) may be used for time alignment. Of course, these speech recognition tasks may be carried out by DSP 11, independently or in collaboration, if it is equipped with a suitable processing unit.

PU 12 may be realized by a conventional Personal Computer, preferably a type of handheld PC, such as pocket-PC or other suitable PDA (Personal Digital Assistance) device. PU 12 should be equipped with at least a 500 MHz CPU (Central processing Unit) and 256 MB RAM. DSP unit 11 may be implemented by a conventional sound card (8 bit or higher) having recording and sound playing capabilities or by any other suitable sound module.

Audio input device 15 may be implemented by any microphone capable of providing audible inputs of relatively good quality. Audio output device 16 may be implemented by speaker(s) capable of providing suitable output volume levels which will be heard in the vicinity of the user using the speech-aid device 6 of the invention. Text input device 10 may be implemented by any conventional keyboard or other suitable text inputting means, preferably, a relatively small size text input device is used that can be conveniently integrated for use in a handheld device. If speech-aid device 6 is implemented utilizing a pocket-PC or PDA then built-in speaker(s), microphone, text inputting means are preferably used as the audio input 15, audio output 16, and text inputting devices.

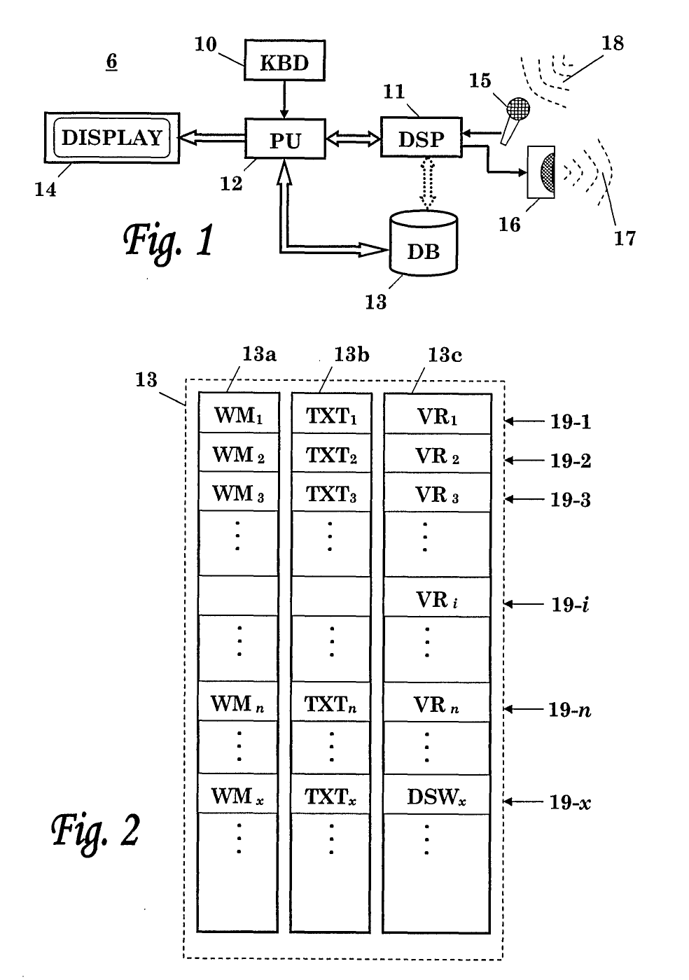

DB 13 preferably comprises a plurality of records 19-1, 19-2, 19-3, . . . , 19-n, each of which comprising data associated with a specific word, as shown in FIG. 2. The words in DB 13 preferably constitute a relatively large vocabulary of spoken words (e.g., 1000-2000 words) in order to cover most of the words that are commonly used orally during everyday life. The records 19 in DB 13 are preferably arranged in an associative manner, such that each record comprises a respective field for storing data associated with the word.

As exemplified in FIG. 2 the first field 13a of each record 19 preferably comprises the WM of the word (WM₁, WM₂, WM₃, . . . , WMₙ) which was generated during the training stage, a second field 13b of records 19 preferably comprises a textual representation of the word (TXT₁, TXT₂, TXT₃, . . . , TXTₙ), and the third field 13c of each record 19 preferably comprises the VR of each word (VR₁, VR₂, VR₃, . . . , VRₙ). As will be explained hereinlater, DB 13 may comprise additional records 19-x for storing data associated with words for which there is no VR in DB 13.

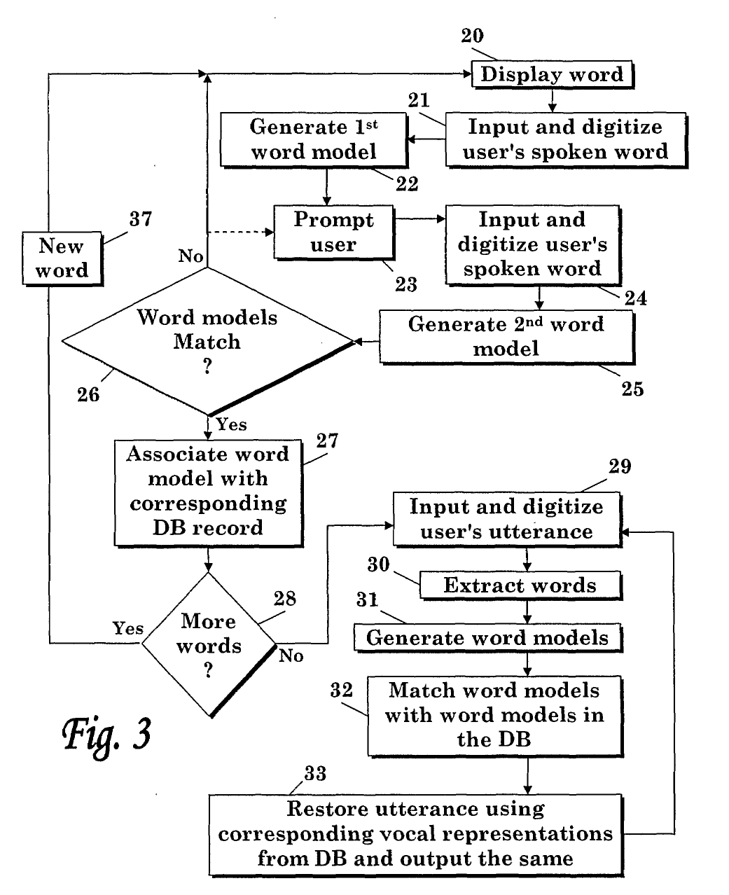

The flow chart shown in FIG. 3 exemplifies the training and operation stages of the invention. Typically, the training of a speech recognition system comprise prompting the user to pronounce a word, analyzing the pronounced word by extracting features therefrom and generating a WM (also known as vocal signature) representing the word as pronounced by the user. In a preferred embodiment of the invention a preset vocabulary of words is arranged in DB 13.

In step 20 one of the records 19-i in DB 13 is chosen and the textual representation TXTᵢ of the word associated with that record is displayed via display 14. Additionally or alternatively, the respective VR of the word VRᵢ may be concurrently outputted via audio output device 16. Next, in step 21, the word spoken by the user 18 in received via audio input device 15 and digitized by DSP unit 11. In step 22 the digitized word is analyzed, features are extracted therefrom, and a first WM is generated. The user is then prompt again to re-pronounce the word in step 23, and in steps 24 and 25 the re-spoken word is inputted, digitized, analyzed, and a second WM is generated therefrom. The first and second WMs are then compared and in step 26 it is determined if there is a match between the WMs. A match may be determined utilizing a similarity test, for example, or other types of test, for example utilizing DTW based techniques.

If it is determined in step 26 that the WMs do not match, then the training of the respective word may be restarted by passing the control to step 20, such that new first and second WMs are generated and then examined in step 26 for a match. Alternatively, a new second WM may be generated by passing the control to step 23 (indicated by dashed line arrow), such that the new WM is compared for a match with the first original WM in step 26. While in this example only two WMs are generated for each trained word, this process may be easily modified to comprise prompting the user to pronounce the word numerous times and generating respective WMs and determining a match therebetween in step 26.

If it is determined in step 26 that the WMs match, then in step 27 the first (or second) WM is associated with the respective word in DB record 19-i, and the WM is stored in the respective field WMᵢ of the record. Next, if it is determined in step 28 that there are additional words in DB 13 that speech-aid device 6 should be trained with, then the training proceeds by passing the control to step 37, wherein a new word is selected from DB 13, and thereafter the training process (steps 20-27) is repeated for the new word as the control is passed to step 20. It should be noted however that it may be difficult to determine a match between WMs generated by individuals with severe speech disabilities, and in such cases the training of certain words may be skipped if after several attempts there is still no match between the generated WMs.

When it is determined in step 28 that the training process of most (or all) of the words stored in DB 13 is completed, the operating. stage may be initiated by passing the control to step 29. In steps 29 to 33 audible inputs are continuously received from the user, the user's utterance is digitized in step 29 and in step 30 words contained in the digitized utterance are extracted. In step 31 WMs are generated for each extracted word and in step 32 the generated WMs are compared with the WMs stored in DB 13 and matching DB records 19 are thereby determined. After matching DB records 19 to most (or all) of the generated WMs the respective VRs are fetched from the matching records and a restoration of the user's utterance is constructed in which the fetched VRs are arranged in the sequence. in which the words were uttered by the user.

If in step 33 the process fails to find a matching DB record to some of the WMs, the respective Digitized Spoken Words (DSW) that were extracted in step 30 may be used in the constructed utterance restoration. The restored utterance is then converted into an analog signal by DSP unit 11 and thereafter it is audibly outputted via audio output device 16.

As mentioned hereinabove DB 13 may comprise records 19-x for storing data associated with words for which there is no VR in the DB. The operation stage may comprise steps in which the WMs of words extracted from the user's digitized utterances for which the process failed to find a matching WM in DB 13 are stored in such records 19-x. For example, the unmatched WM, WMₓ, and the respective DSW, DSWₓ, comprising the user's digitized spoken word, may be stored in the respective fields, 13a and 13c, of a DB record 19-x. The user may be then prompt (or at a later time by outputting DSWₙ for example) to enter via text input device 10 a textual representation TXTₓ for the unmatched WMs.

If it is found that there is another DB record 19-i containing a textual representation TXTᵢ identical to TXTₓ, then the training process for that specific record 19-i is repeated in order to improve the speech recognition of the system. If DB 13 does not comprise a record with a textual representation TXTₓ than the user may apply to a service, for example—at a customer service location or via the internet, and request to receive a corresponding VR (VRₓ which will replace DSWₓ in the 13c field) and thereby add a new word to the word vocabulary of the system.

The recognition performed in the training and/or operating stages may be improved by utilizing an ontology-based ranking procedure. In this way the quality of the speech recognition and of the output restoration may be substantially improved. Such ontology-based ranking procedure, may comprise two different schemes: i) used for checking the semantic plausibility of hypotheses of word sequences; ii) patients' impairments paired with their presumed effects on articulation, which may be used in the speech recognition process to rank hypotheses based on knowledge of the level of user's uttered words and/or sequences.

For this purpose an ontology database is preferably used for storing information about plausible co-occurrences of words within the user's utterance. This ontology database may for example comprise context of previously recognized content words, which enables the computation of a semantic relevance metric, which provides an additional criterion for deciding between competing hypotheses. Preferably, semantic preferences are employed by directing the search of the word hypothesis graph that is the intermediate result of the speech recognizer. The DTW based speech recognition mechanism of the invention can be modified to provide a list of n-best hypotheses, along with their distances from the respective WMs (e.g., DTW templates). These distances are then factored together with an ontology-based semantic ranking, a general corpus-based language model, and an adaptive language model, which is created during the system's speaker-training phase and expanded later on during regular usage.

For example, to each hypothesis in a given list of n-best Speech Recognition Hypothesis (SRHs) H₁ . . . Hₙ, a rank rᵢ is assigned, wherein said rank is a function of various metrics, rᵢ=φ(sᵢ,dᵢ,lᵢ, aᵢ), where the arguments sᵢ, dᵢ, lᵢ, and aᵢ, respectively, represent the semantic distance metric, the recognition distance, the general language model, and the user-specific language model respectively. A simple realization of such a function may be as follows

rᵢ=ωₛsᵢ+ω_{d}dᵢ+ωᵢlᵢ+ωₐaᵢ.

Of course other weighting schemes (non-linear or piecewise-linear) may be used instead.

The patients' impairments ontology scheme may be advantageously used to develop a static user model based on the user's specific impairments.

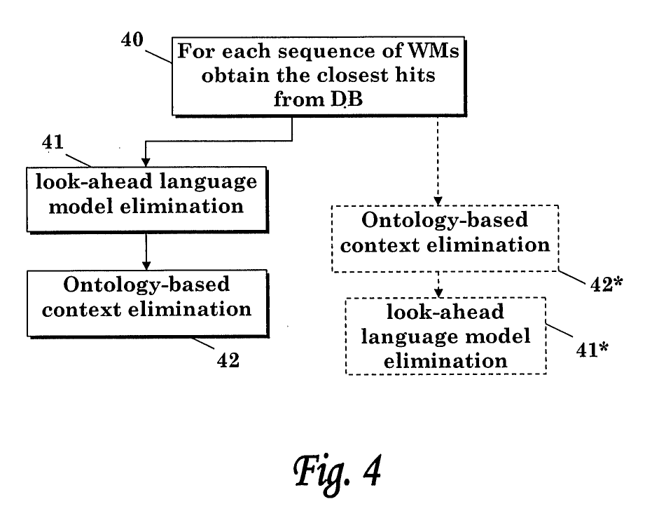

FIG. 4 is a flowchart exemplifying a procedure for improved recognition of words provided in a sequence of spoken words, which may be used in the method and device of the invention. Steps 40 to 42 of the procedure illustrated in FIG. 4 may be employed after comparing the generated WMs with the WMs (WMᵢ) stored in the database and finding matching database records (Step 32 in FIG. 3). Since the similarity tests used for comparing the WMs of the spoken words with the WMs (WMᵢ) in the database of the device may yield several plausible matches, language models and/or ontology based tests are advantageously utilized to improve the word recognition of the device.

In step 40 a set of the closest matches WM₍ₛ₎ for each WM of a spoken word in a sequence of spoken words is determined using any suitable similarity test (e.g., DTW). In step 41 a look-ahead language model is used to determine the likelihood of each WM in said set WM₍ₛ₎ of closest matches. Step 41 may substantially reduce the number of matches for some, or all, of the WMs generated for a spoken sequence of words. The language model used in step 41 may be any type of suitable language model, such as, but not limited to, n-gram language model, preferably a tri-gram language model.

If the language model used in step 41 fails to determine a matching WM for some of the words in said spoken sequence then in step 42 ontology-based context tests are utilized to determine the most likelihood matches for the same. In general, the ontology-based context tests used in step 41 examines the words in the spoken sequence of words for which a matching WM was determined, and accordingly determines the context of the sentence. Thereafter, by way of elimination, the number of possible matches in each set of closest matches is further reduced by discarding matches which are contextually not acceptable in said sequence of spoken words.

If after carrying out step 42 there are still WMs of spoken words with more than one matches the procedure may be repeated by transferring the control back to step 40. Of course, the order of operations may be reversed such the ontology-base tests are carried our first followed by the look-ahead language model step, as indicated by the dashed lines steps 42* and 41* shown in FIG. 4.

The use of language models and ontology-based context algorithms in speech recognition applications is well known in the art and may be implemented using software modules of such algorithms.

The speech-aid device 6 of the invention may be used to aid individuals in oral communication with foreign languages. For example, after completing the training stage (step 20 to 27) the VR fields 13c of each DB record 19 (e.g., VRᵢ) may be replaced by the corresponding VRs of the trained words in a desired foreign language. Alternatively, corresponding VRs of the trained words of one or more desired foreign languages may be added in an associative manner to each record 19 and the language to be used by speech-aid device 6 during its operation will be selected by the user using a user interface (or by using an electrical switching device) provided via display 14. For example, the speech-aid device 6 may be trained to recognize words spoken by the user in the English language (i.e., utilizing. English textual representations e.g., TXTᵢ) while in operation the user may select to use corresponding VRs in Spanish.

Additionally, the VRs in the database records 19 in the speech-aid device 6 of the invention may be adapted according to vocal characteristics of the user in order to provide vocal outputs which will be closer in sound to the user's voice. For example, by modifying the pitch (basic tone, “height” of the voice), to the user's pitch.

The above examples and description have of course been provided only for the purpose of illustration, and are not intended to limit the invention in any way. As will be appreciated by the skilled person, the invention can be carried out in a great variety of ways, employing more than one technique from those described above, all without exceeding the scope of the invention.

1. A speech aiding device, comprising: DSP means for digitizing audio signals received via an audio input device and for converting digital data into an audible output via an audio output device; processing unit adapted to receive and transfer data from/to said DSP means and execute programs comprising speech recognition module(s); memory(s) adapted to transfer/receive data to/from said processing unit; and a database stored in said memory(s), wherein said database comprises a plurality of records each of which comprising at least a word model and a textual and a vocal representation of a specific word, and wherein said word model comprises features extracted from a digitized word spoken by said user.

2. The device of claim 1, further comprising a text input device attached to the processing unit for inputting text thereto.

3. The device of claim 1, further comprising additional processing means embedded in the DSP means.

4. The device of claim 1, further comprising a display device attached to the processing unit.

5. The device of claim 1, wherein the processing unit is a personal computer, a pocket PC, or a PDA device.

6. The device of claim 1, wherein the memory(s) comprise, one or more of the following memory device(s): NVRAM, FLASH memory, magnetic disk, and/or R/W optic disk.

7. A method for correcting mispronunciations of a user, comprising: providing a database comprising a plurality of records each of which comprising at least a textual and a vocal representation of a specific word; training a speech recognition module to recognize spoken utterances of said user comprising the words represented by said records; generating word models for each recognized spoken word; associating each word model with a respective database record;
after training said speech recognition module with sufficient words receiving spoken utterance from said user; extracting a sequence of words from said spoken utterance and generating a word model for each extracted word; comparing said word models to the word models associated with said database records; constructing an audible output comprising vocal representations obtained from records which their word models matched word models generated for said extracted word,
wherein said word models comprises features extracted from data of the words spoken by said user.

8. The method of claim 7, wherein the vocal representations of each database record constitute correct pronunciation the word associated with said record.

9. The method of claim 8, wherein the database records comprise vocal representations of the words in one or. more languages, and wherein the language of vocal representations to be used is selected by the user.

10. The method of claim 7, further comprising utilizing a language model to eliminate the matching of wrong words from the database.

11. The method of claim 7, further comprising carrying out ontology-based contextual tests to eliminate the matching of wrong words from the database.

12. The method of claim 10, wherein the language model used in a trigram model.
